(19) United States
(12) Patent Application Publication
(10) Pub. No.: US 2005/0218559 A1
(43) Pub. Date: Oct. 6, 2005

(54) Winding apparatus and method for production of helixes from a plastic filament

(76) Inventor: Michael Rempfer, Neuffen (DE)

Correspondence Address: FLYNN THIEL BOUTELL & TANIS, P.C., 2026 RAMBLING ROAD, KALAMAZOO, MI, 49008-1631, US

(21) Appl. No.: 11/096,734

(22) Filed: Apr. 1, 2005

(30) Foreign Application Priority Data
Apr. 5, 2004 (DE) 102004017798.8

(51) Int. Cl. B29C 53/32

(52) U.S. Cl. 264/281; 425/391

(57) ABSTRACT

Winding apparatus for production of helixes from a plastic filament. A winding apparatus having an input unit, by means of which the plastic filament can be supplied to a shaping unit, in which the plastic filament can be shaped into the helix by means of at least one shaping element, is known. According to the invention, the shaping element is arranged immediately after the input unit in the filament running direction, and the guide surface of the shaping element is aligned so as to be inclined with respect to a filament transport axis of the input unit such that the plastic filament can be shaped continuously with a radius of curvature which is greater than a cross-sectional radius of the plastic filament and is substantially smaller than a helix radius in the finished state. Use for the production of plastic helixes.

The invention relates to a winding apparatus for production of helixes from a plastic filament, having an input unit, by means of which the plastic filament can be supplied to a shaping unit, in which the plastic filament can be shaped into the helix by means of at least one shaping element which has a guide surface for the plastic filament, and to a method for production of the plastic helixes.

Such a winding apparatus is disclosed by DT 19 44 371. The known winding apparatus permits the production of helixes from a thermoplastic filament. The plastic filament is heated up within the winding apparatus by means of a filament heating device and introduced into guide grooves twisted in the shape of a helix. By means of a filament cooler, the heated plastic filament is cooled down again. The brief heating leads to the plastic filament assuming its helical shape, assumed by the guide grooves, plastically rather than elastically. As a result of the subsequent cooling, the plastic filament is fixed in its helical shape. The plastic filament is thus shaped in the hot state and kept in the helical form created by means of cooling.

It is an object of the invention to provide a winding apparatus and a method of the type mentioned at the beginning which permit helix production without the external supply of energy for heating or cooling of the helixes.

For the winding apparatus, this object is achieved in that the shaping element is arranged immediately after the input unit in the filament running direction, and in that the guide surface of the shaping element bears on the outside of the plastic filament and is aligned so as to be inclined with respect to a filament transport axis of the input unit such that the plastic filament can be shaped continuously with a radius of curvature which is greater than a cross-sectional radius of the plastic filament and is substantially smaller than a helix radius in the finished state, in particular smaller than half the helix radius.

By means of the solution according to the invention, it is surprisingly possible to bring a thermoplastic filament into helix form without any heating of the plastic filament being needed for this purpose. Instead, the helixes are created by cold shaping. The plastic filament preferably has a cross section between 0.5 mm and 3 mm diameter. The plastic helixes can be used as helical springs or else in particular for binding blocks of sheets which are provided with appropriate perforations in the region of the spine. The materials that can be used for the plastic helixes are all types of thermoplastics, such as PVC, PET or else thermoplastic elastomers.

In a refinement of the invention, a guide element acting on the outside of the plastic filament is provided in a first turn of the helix and, relative to a helix axis, has a greater axial spacing than the guide surface of the shaping element, the axial spacing being less than the radius of the finished helix. By means of the guide element, supporting guidance can be achieved in the region of the outer circumference of the first turn of the helix to be produced. In the region of the shaping element, the intensive cold shaping of the plastic filament is carried out. The guide element ensures the exact matching of the helix diameter to be achieved subsequently in a coordinated supplement to the shaping element. The shaping element is also positioned relative to the plastic filament such that its guide surface supports the plastic filament only in the region of the outer circumference of the helix to be formed. Cylindrical plastic helixes can advantageously be produced by means of the solution according to the invention.

In a further refinement of the invention, the shaping element is mounted such that it can be moved by means of a disengagement device in such a way that the shaping element can be moved so far away from the helix that the shaping element releases the helix without contact. In addition, provision can advantageously be made for the guide element also to be moved away from the helix by means of the disengagement device. The refinement described ensures that, during the production of the helix, appropriate shaping acts uniformly on the continuously conveyed plastic filament. As soon as the plastic filament is no longer conveyed further, the shaping element and, if appropriate, the guide element is removed from the helix, in order to avoid undesired deformation of the plastic filament when the winding apparatus is at a standstill. In order to start up the winding apparatus again, the shaping element and, if appropriate, the guide element are fed against the plastic filament again and the conveyance of the plastic filament is also started again, approximately simultaneously with the support provided for the plastic filament.

In a further refinement of the invention, an actuating element for setting a pitch of the helix is provided. By means of the shaping element and the guide element, the desired diameter of the helix to be produced can be set. The actuating element is used to adjust the pitch of the helix. Both the shaping element and the guide element and the actuating element are preferably provided with appropriate actuating drives, which are driven by a common control unit. A conveying drive of the input unit is preferably connected to the control unit. The actuating drive of the shaping element is assigned to the disengagement unit. If the guide element can likewise be actuated by the disengagement device, the guide element can be moved by the common actuating drive of the disengagement device. The conveying drive of the input unit and an appropriate actuating drive for the disengagement device are preferably coupled to each other in such a way that, when the conveying device is at a standstill, the disengagement device moves the shaping element and, if appropriate, the guide element away from the plastic filament and, in a correspondingly converse manner, when the conveying drive is started, the shaping element and, if appropriate, the guide element are moved back into the initial position again. The control unit preferably has a data storage means, in which data for different helix sizes and pitches, different plastic materials and different production speeds are stored, in order to permit the control or regulation of corresponding production operations for different helixes. The winding apparatus is preferably provided for production of cylindrical helixes. In the same way, however, helixes which taper conically or widen conically can also be produced if, during the production process, the shaping element and the guide element have their position changed appropriately.

In a further refinement of the invention, the input unit has a pair of input rollers which transport the plastic filament, at least one input roller being provided with a contact surface with a high coefficient of friction. This refinement takes account of the fact that the cross section of plastic filaments would be deformed in the event of excessively high contact forces of the input rollers. This would be undesired. The fact that an increased coefficient of friction is provided in the region of the contact surface that is used to convey the plastic filament means that an adequate transport moment can be achieved in spite of a reduced contact force.

A substantial advantage of the solution according to the invention is that the winding apparatus can be used both for production of plastic helixes and for the production of filaments from metal wire, in particular steel wire.

In a further refinement of the invention, the contact surface has a frictional coating. The contact surface extends over the entire circumference of the input roller and is provided at least in the annular region in which the plastic filament rests on the input roller. The frictional covering provided can either be a coating permanently connected to the input roller or else a covering or coating connected detachably or non-detachably to the input roller.

In a further refinement of the invention, the contact surface is formed by mechanical surface profiling. Here, in particular, knurling can be provided in order to achieve mechanical roughening of the contact surface.

In a further refinement of the invention, at least one input roller is mounted such that it can be moved orthogonally in relation to the filament transport axis, and the input roller is assigned a force control device which exerts an adjustable contact force of the input roller on the filament. The force control device makes it possible to coordinate the contact force of the input roller with different thread diameters of the plastic filament or with different plastic materials.

In a further refinement of the invention, a sheet binding apparatus is provided, which has means for the helical twisting of filament helixes into perforations in sheet spines, and the sheet binding apparatus is positioned adjacent to the winding apparatus in such a way that a holding region of the sheet binding apparatus, to which the twisting means are assigned, is arranged in coaxial extension of a helix-shaping region of the winding apparatus. This makes it possible to bind the helixes produced continuously into corresponding blocks of sheets in a single operation. On the outlet side of the helix forming region, the helical production of the helixes permits these helixes to be screwed directly into the spines of a block of sheets, in order to achieve block binding of loose sheets. The corresponding helix is cut to length as soon as it has been rotated completely into the spine of the block of sheets. The correspondingly bound block of sheets can then be removed and replaced by a further block of sheets still to be bound. The configuration is time-saving, since both the helix production and the binding of the helix into a corresponding block of sheets are achieved in one operation.

In addition to automatic helix production, in order also to be able to achieve automatic binding of the helixes in corresponding sheet spines, sensor means are preferably provided which register the length of the sheet spine and the position of the perforations. By means of a control unit, the data acquired is processed and used firstly for setting helix diameter and helix pitch in the region of the winding apparatus and secondly for activating a separating unit, by means of which the helixes are cut suitably to length.

The control unit is preferably designed in such a way that variables influencing the helix diameter of the plastic helix to be produced, such as the threading speed of the threading rolls, diameter of the plastic filament, mechanical characteristics of the plastic filament, such as in particular tensile strength, extension at fracture and the like, and other data are taken into account.

In order to achieve the object stated at the beginning, provision is additionally made by the invention, in a method for production of plastic helixes, to produce the plastic helixes from at least one plastic filament by means of continuous cold shaping. As compared with known methods, in which heating and subsequent cooling of the plastic filaments is needed, this method saves both time and costs.

In a further refinement of the invention, the plastic filament is guided exclusively on its outside in the circumferential direction during its shaping. In known methods for production of plastic helixes, the plastic filament is wound around a mandrel and therefore supported on its inner circumference. According to the invention, the support and therefore cold shaping are carried out exclusively in the region of the outer circumference of the turns. In addition, support for the purpose of definition of a pitch of the helix is provided by a cross section of the plastic filament. The existing elasticity of the plastic filaments ensures that contact and guidance of the respective plastic filament are always achieved on the outside during the production of the helix.

Further advantages and features of the invention emerge from the claims and from the following description of a preferred exemplary embodiment of the invention, which is illustrated by using the drawings.

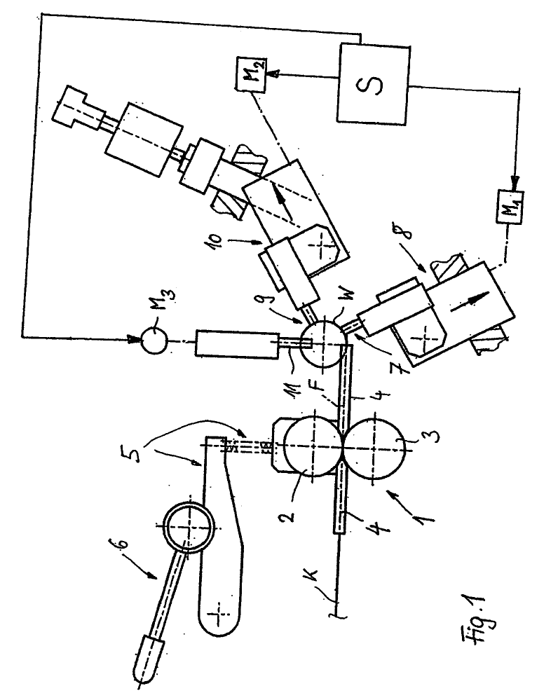

FIG. 1 shows, in schematic form, an embodiment of a winding apparatus according to the invention, and

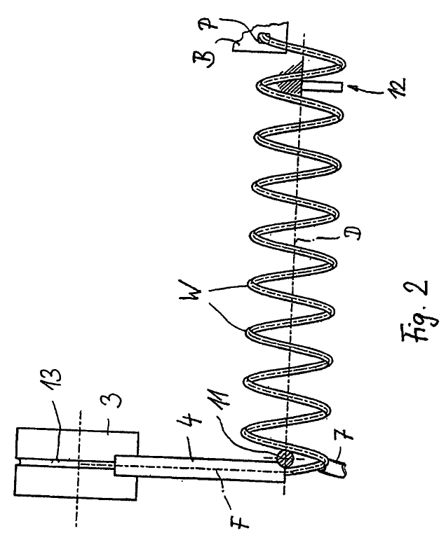

FIG. 2 shows, schematically in an enlarged illustration in a plan view, a helix produced and subsequent incorporation in a block of sheets within a sheet binding apparatus.

A winding apparatus for production of plastic helixes has an input unit 1, by means of which a plastic filament K is transported to a helix forming region. The plastic filament K is drawn endlessly from a storage roll, not specifically illustrated, and introduced into a rectilinear feed duct 4. The feed duct 4 forms a closed hollow profile, of which the free cross section is only slightly larger than a filament cross section of the plastic filament K. As a result, the plastic filament K is conveyed rectilinearly through the feed duct 4. The feed duct 4 is divided into two duct sections which, as viewed in the filament running direction, are positioned before and after a pair of input rollers 2, 3. The pair of input rollers 2, 3 is used to convey the plastic filament K continuously into the helix forming region. At least one of the two input rollers 2, 3 is provided with a drive, not specifically designated, preferably an electric motor. In the exemplary embodiment illustrated, the plastic filament K is conveyed horizontally through the feed duct 4 to the helix forming region. A corresponding conveying transport axis F runs in the plane of the drawing according to FIG. 1. A helix axis, which is not specifically illustrated in FIG. 1 and which defines an imaginary axis of rotation for the helical movement during the production of a helix W, runs orthogonally in relation to the filament transport axis F into the plane of the drawing. In FIG. 2, the helix axis is provided with the reference symbol D.

The two input rollers 2 act on the plastic filament K above and below the latter. The upper input roller 2 is provided with a force control device 5, 6, in order to be able to set a contact force between the upper input roller 7 and the plastic filament K. In the embodiment according to FIG. 1, the actuating element provided is a mechanical actuating lever 6 in the form of an eccentric, in order to effect an appropriate change in the contact force. In the same way, an electric, pneumatic or hydraulic actuating drive can be provided. In the region of its contact surface 13 (FIG. 2) which is designed in the form of an annular groove, at least one of the two input rollers 2, 3 is provided with an increased coefficient of friction as compared with the remaining surface of the input roller 2. This can be done by roughening the surface of the input roller 2 or 3 in the region of the contact surface 13. The roughening can be achieved by means of knurling or mechanical roughening configured in another way. Alternatively, it is possible to create the increased friction of the contact surface 13 by means of a frictional coating, in particular in the form of a coating or a covering.

Positioned immediately after an outlet region of the rear duct section in the filament transport direction is a shaping element 7 which, with its guide surface, not specifically designated, has the effect of deflecting the plastic filament K upward, and therefore of corresponding cold shaping of the plastic filament K. The guide surface is preferably configured in the manner of a groove or channel, in order to effect exact guidance of the plastic filament K and to prevent the plastic filament K escaping laterally. In order to give the plastic filament K the necessary helix pitch, an actuating element 11 is provided which, in the manner of a finger, forces on the plastic filament K, by means of lateral support and guidance, an inclination which effects the desired pitch of corresponding turns during the continuous conveyance of the plastic filament K. For the purpose of improved guidance and support of the plastic filament K, after the shaping element 7 in the filament running direction, a guide element 9 is provided which has a greater radial spacing from the helix axis D than the shaping element 7. The guide element 9 is arranged to be offset in relation to the shaping element 7 in the circumferential direction of the helix W to be produced. In addition, the guide element 9 is also offset slightly in relation to the shaping element 7 in the axial direction of the helix axis D, in order to follow the pitch angle forced by the actuating element 11.

The shaping element is set so sharply relative to the filament transport axis F that the plastic filament K experiences a relatively sharp deflection in the region of the shaping element 7. The radius of curvature formed for the incoming plastic filament K is greater than a cross-sectional radius of the plastic filament K but, at the same time, substantially smaller than a final radius of curvature of the finished helix W. As a result of the plastic material, the plastic filament K has a relatively high restoring force, so that the helix W in the region of the shaping element 7 and of the guide element 9 has to be shaped so as to be smaller than is needed for its final diameter. The fact that the guide element 9 has a greater radial spacing from the helix axis D than the shaping element 7 means that the guide element 9 merely works in a limiting manner for the plastic filament K and not in an actively shaping manner, as is done by the shaping element 7. The radial spacing of the guide element 9 is matched to the radial spacing of the shaping element 7 from the helix axis D by using predefined setting data, in order that it is ensured in each case that the intensive cold shaping of the plastic filament K is carried out in the region of the shaping element 7, and the subsequent support and maintenance of a suitable helix curvature and tension can be carried out by the guide element 9.

The shaping element 7 is assigned a disengagement unit 8. The guide element 9 is also assigned a disengagement unit 10. The two disengagement units 8, 10 are used to move the shaping element 7 and the guide element 9, respectively, radially outward and in this way to move the shaping element 7 and the guide element 9, respectively, away from the plastic filament K and the helix W. Each disengagement unit 8, 10 has a preferably electric-motor actuating drive M₁, M₂ which, in addition to an appropriate disengagement operation, also control an opposite feeding movement. The actuating element 11 is provided with an actuating drive M₃, by means of which the actuating element 11 can be displaced axially parallel to the helix axis D, in order to be able to set the desired pitch.

All three actuating drives M₁, M₂, M₃ are connected to a central control unit S, which effects coordinated driving of the various actuating drives M₁ to M₃. The control unit S has, in a manner not specifically illustrated, a data storage means for this purpose, in which various setting values for the appropriate actuating drives M₁ to M₃ are stored for different helix diameters and different helix pitches and also for different diameters of the plastic filament K, for different material properties of the respective plastic filament K and for different conveying speeds of the plastic filament K. The individual actuating drives can be driven by means of the control unit S by means of a predefined program. It is also possible to achieve regulation of the helix production operation by means of appropriate interrogation of the actual values of physical data from the actuating drives and from the conveying drive of the input unit 1. Thus, even the conveying drive of the input unit 1 and the force control device in the region of the input unit 1 are preferably also connected to the control unit S, in order to be able to achieve an automatically controlled helix production process.

In an exemplary embodiment of the invention which is not illustrated, the shaping element 7 and the guide element 9 are assigned a common disengagement unit.

Alternatively, two disengagement units are provided, which can preferably be actuated by means of a common mechanical control device.

Also stored in the control unit S is a control program which positively effects displacement of the guide element 9 and the shaping element 7 and therefore of the corresponding disengagement units 8, 10 as a function of the activation or deactivation of the conveying drive of the input unit 1. This ensures that, if the conveying drive is stopped and, accordingly, the plastic filament K is braked, the shaping element 7 and preferably also the guide element 9 are brought out of engagement with the plastic filament K. Undesired deformations of the plastic filament K when at a standstill are avoided in this way. As soon as the conveying drive starts up again and the plastic filament K is transported again, the shaping element 7 and the guide element 9 are fed into the desired positions again.

In an exemplary embodiment of the invention which is not illustrated, only the shaping element 7 is provided in order to achieve the cold shaping of the plastic filament K. The guide element 9 is omitted. Even using only a single shaping element 7, together with an actuating element 11 for producing an appropriate helix pitch, it is possible to produce a helix W. The positioning of the shaping element 7 has to be varied in this embodiment as compared with the illustration of FIG. 1. Here, the shaping element 7 preferably has a somewhat greater spacing from the outlet region of the feed duct 4 than in the embodiment having a guide element. The angle at which the shaping element 7 is aligned relative to the filament transport axis F must also be changed appropriately.

As can be seen from FIG. 2, it is possible to combine the winding apparatus with a sheet binding apparatus, in which the continuously produced helix W is bound uniformly in perforations P of a block of sheets B. For this purpose, the block of sheets B is aligned within the sheet binding apparatus in such a way that a corresponding holding region of the sheet binding apparatus for the block of sheets B is aligned in coaxial extension of the helix axis D and therefore of the helix forming region of the winding apparatus. The perforations P are matched to the helix pitch in such a way that the helix W can be screwed gradually into the perforations by means of rotation about the helix axis D. In this way, the desired binding of the block of sheets B comprising a large number of loose sheets is achieved positively. As soon as the appropriate helix W has been screwed into the perforations P of the block of sheets B over the entire length of the block of sheets B, the helix W must be cut off. For this purpose, a separating unit 12, merely illustrated schematically, is provided. The control unit S can be designed in such a way that, in addition to the automatic helix production, it also permits automatic binding of the helixes W in corresponding sheet spines of appropriate blocks of sheets B.

1. Winding apparatus for production of helixes from a plastic filament, having an input unit, by means of which the plastic filament can be supplied to a shaping unit, in which the plastic filament can be shaped into the helix by means of at least one shaping element which has a guide surface for the plastic filament, characterized in that the shaping element (7) is arranged immediately after the input unit (1) in the filament running direction, and in that the guide surface of the shaping element (7) bears on the outside of the plastic filament and is aligned so as to be inclined with respect to a filament transport axis (F) of the input unit (1) such that the plastic filament (K) can be shaped continuously with a radius of curvature which is greater than a cross-sectional radius of the plastic filament (K) and is substantially smaller than a helix radius in the finished state, in particular smaller than half the helix radius.

2. Winding apparatus according to claim 1, characterized in that a guide element (9) acting on the outside of the plastic filament is provided in a first turn of the helix (W) and, relative to a helix axis (D), has a greater axial spacing than the guide surface of the shaping element (7), the axial spacing being less than the radius of the finished helix (W).

3. Winding apparatus according to claim 1, characterized in that the shaping element (7) is mounted such that it can be moved by means of a disengagement device (8) in such a way that the shaping element can be moved so far away from the helix (W) that the shaping element (7) releases the helix (W) without contact.

4. Winding apparatus according to claim 1, characterized in that an actuating element (11) for setting a pitch of the helix (W) is provided.

5. Winding apparatus according to claim 1, characterized in that a control unit (S) is provided, which performs a displacement of the shaping element (7) and/or a displacement of the guide element (9) and/or a displacement of the actuating element (11), individually or jointly.

6. Winding apparatus according to claim 1, characterized in that the input unit (1) has a pair of inlet rollers (2, 3) which transport the plastic filament (K), at least one input roller being provided with a contact surface (13) with a high coefficient of friction.

7. Winding apparatus according to claim 6, characterized in that the contact surface (13) has a frictional coating.

8. Winding apparatus according to claim 6, characterized in that the contact surface is provided by means of mechanical surface profiling.

9. Winding apparatus according to claim 6, characterized in that at least one input roller (2) is mounted such that it can be moved orthogonally in relation to the filament transport axis (F), and in that the input roller (2) is assigned a force control device (5, 6) which exerts an adjustable contact force of the input roller (2) on the plastic filament (K).

10. Winding apparatus according to claim 1, characterized in that a sheet binding apparatus is provided, which has means for the helical twisting of filament helixes into perforations in sheet spines, and in that the sheet binding apparatus is positioned adjacent to the winding apparatus in such a way that a holding region of the sheet binding apparatus, to which the twisting means are assigned, is arranged in coaxial extension of a helix-shaping region of the winding apparatus.

11. Winding apparatus according to claim 1, characterized in that sensor means for registering the finished helix length are provided.

12. Winding apparatus according to claim 11, characterized in that a separating unit (12) is provided to cut helixes (W) to length.

13. Method for production of plastic helixes, characterized in that the plastic helixes are produced from at least one plastic filament (K) by means of continuous cold shaping.

14. Method according to claim 13, characterized in that the plastic filament (K) is guided exclusively on its outside in the circumferential direction during its shaping.
